(19) United States
(12) Patent Application Publication
(10) Pub. No.: US 2016/0181678 A1
(43) Pub. Date: Jun. 23, 2016

(54) BAND-REJECTION FILTER

(71) Applicant: THOMSON LICENSING, Issy les Moulineaux (FR)

(72) Inventors: Jean-Luc ROBERT, Betton (FR); Dominique LO HINE TONG, Rennes (FR); Jean-Yves LE NAOUR, Pace (FR)

(73) Assignee: THOMSON LICENSING, Issy les Moulineaux (FR)

(21) Appl. No.: 14/902,589

(22) PCT Filed: Jul. 4, 2014
(86) PCT No.: PCT/EP2014/064107

§ 371 Date: Jan. 3, 2016

(30) Foreign Application Priority Data
Jul. 4, 2013 (FR) 1356567

(51) Int. Cl. H01P 1/203

(52) U.S. Cl. CPC H01P 1/203

(57) ABSTRACT

The present invention relates to a band-rejection filter comprising, on a substrate with a ground plane, three printed line sections or “stubs” open circuit at one of their extremities, called first extremities, and first and second printed transmission lines connected in series between an input terminal and an output terminal and connecting between each other the other extremities, called second extremities, said stubs, each of said first and second transmission lines being inserted between the second extremities of two stubs, said stubs being dimensioned to reject a first frequency band. According to the invention, an open circuit stub is inserted in at least one of said first and second printed transmission lines to reject a second frequency band.

### TECHNICAL FIELD

The present invention relates to the domain of multi-standard or multi-radio terminals, particularly to terminals comprising a plurality of radio frequency circuits realized on a same printed circuit board.

The invention relates more particularly to a band-rejection filter that can be used in such terminals to enable the coexistence of radio frequency circuits operating at different frequencies on a same printed circuit board.

### PRIOR ART

When several radio frequency circuits are implemented on a same electronic board, the board must be designed so that the different radio-frequency circuits can coexist and that each of the circuits can operate without polluting the others. This constraint is all the stronger as the radio circuits are very close on the electronic board owing to the high level of integration required.

FIG. 1 diagrammatically illustrates the multi-radio context in an electronic board of a decoder terminal (or Set Top Box).

This terminal comprises a WiFi transmitter/receiver operating at the frequency of 2.4 GHz, a DECT transmitter/receiver operating at the frequency of 1.9 GHz and a GPS receiver. The arrows show that, when the WiFi transmitter transmits signals, these signals are captured by the antennas of the DECT and GPS receivers.

A radio-frequency analysis of this terminal shows that an isolation of about 45 dB is required to protect the DECT receiver from the noise floor at 2.4 GHz. Conversely, when the DECT circuit transmits, the 1.9 GHz signal is perceived as a high level interference for the WiFi receiver. It is also important to protect the GPS receiver from the noise floor generated by the other transmitters, given that the sensitivity of the GPS receiver is generally very low in the order of −135 dBm. This means that the slightest noise generated by the WiFi transmitter or the DECT transmitter can interfere with the GPS reception.

Specific filters must therefore be added to the WiFi circuit, both in the transmission part and the reception part, to resolve these problems of coexistence. A possibility would be to use an antenna with an integrated filter. However, current 2.4 GHz antennas with integrated filters only provide an isolation of 10 dB in relation to the DECT band. An additional isolation of 10 dB could be obtained by increasing the distance between the DECT antenna and the WiFi antenna, but this would be insufficient.

Another possibility consists in inserting a band-rejection microstrip filter in transmission and reception between the WiFi antenna and the rest of the circuit. For example, band-rejection filters are known that comprise open circuit line sections or stubs connected to each other by transmission lines.

Such a rejector filter is shown in FIG. 2. This filter is realised on a substrate with ground plane. It comprises three stubs 20, 21 and 22 having a first extremity open circuit and two printed transmission lines or microstrip lines 10 and 11 connected in series between an input 1 and an output 2. The microstrip lines 10 and 11 connect between each other the extremities, called second extremities, of the stubs, the microstrip line 10 being inserted between the second extremities of the stubs 20 and 21 and the microstrip line 11 being inserted between the second extremities of the stubs 21 and 22.

The stubs are dimensioned to reject or filter a given frequency band, for example the frequency band of the DECT signals or that of the GPS signals. This rejection is realised by using stubs and transmission lines of length λ/4, where λ is the wavelength corresponding to the central frequency of the frequency band to filter.

An analysis of this filter showed that the rejection is mainly linked to the length of the stubs (λ/4). The length of the transmission lines 10 and 11 is less critical and can vary around λ/4 without notable deterioration in the rejection.

This filter topology with simple microstrip lines and stubs cannot however obtain high rejection levels such as the ones required to cut off the DECT band and/or GPS in the aforementioned application.

Moreover, this filter can only reject a single frequency band, which is fixed by the length of the stubs.

### SUMMARY OF THE INVENTION

One purpose of the invention is to propose a band-rejection filter with microstrip lines having a high rejection level.

Another purpose of the invention is to propose a band-rejection filter that has a simple design and that is able to reject several frequency bands.

For this purpose, the invention proposes a band-rejection filter comprising, on a substrate with a ground plane, three printed line sections or “stubs” open circuit at one of their extremities, called first extremities, and first and second printed transmission lines connected in series between an input terminal and an output terminal and connecting between each other the other extremities, called second extremities, said stubs, each of said first and second transmission lines being inserted between the second extremities of two stubs, said stubs being dimensioned to reject a first frequency band. According to the invention, an open circuit stub is inserted in at least one of said first and second printed transmission lines to reject a second frequency band.

According to a particular embodiment, the first and second frequency bands are substantially identical. Hence, the open circuit stubs and the one inserted into at least one of the printed transmission lines contribute to rejecting the same frequency band and to reaching a high level of rejection of this band.

As a variant, said and first frequency bands are different. The filter can reject two frequency bands.

Preferably, open circuit stubs are inserted in the two printed transmission lines to increase the level of rejection of the second frequency band.

According to a particular embodiment, the filter further comprises at least one third printed transmission line in which is inserted an open circuit stub, said third transmission line being connected in series with said first and second printed transmission lines and inserted between the input terminal and the first transmission line or between the second transmission line and the output terminal, said stub being dimensioned to reject a third frequency band.

According to a particular embodiment, said third frequency band is identical to the one of said first and second frequency bands. This additional stub can increase the rejection level of the one of said first and second frequency bands.

According to another particular embodiment, the third frequency band is different from said first and second frequency bands. If the three frequency bands are different, the filter can then cut off three frequency bands.

According to a particular embodiment, the substrate is a low cost substrate, such as the substrate commonly known as FR4. Analyses have shown that the filter of the invention is not sensitive to any drift in the electrical properties of the substrate used.

Other advantages may also occur to those skilled in the art upon reading the examples below, illustrated by the annexed figures, given by way of illustration.

### BRIEF DESCRIPTION OF THE FIGURES

FIG. 1 shows a diagram of a terminal comprising a plurality of radio systems realised on a same printed circuit board and operating at different frequencies,

FIG. 2 shows a diagram of a band-rejection filter of the prior art,

FIG. 3 shows the diagram of a band-rejection filter according to a first embodiment of the invention,

FIG. 4 shows the diagram of a band-rejection filter according to a second embodiment of the invention,

FIG. 5 shows the diagram of a band-rejection filter according to a third embodiment of the invention, and

FIG. 6 shows a curve illustrating the rejection performances of a filter compliant with the invention.

### DESCRIPTION OF THE INVENTION

According to the invention, a band-rejection filter is proposed in which open circuit stubs are inserted in the transmission lines connecting the 3 stubs traditionally used.

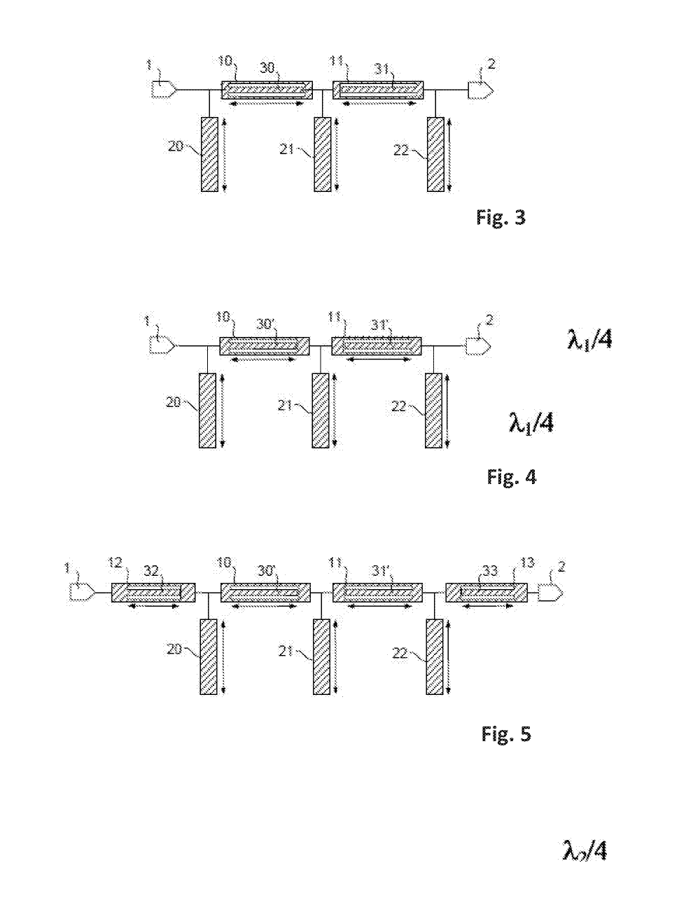

A first embodiment of the filter of the invention is shown diagrammatically in FIG. 3. The elements already present in FIG. 2 have the same references.

With reference to FIG. 3, the filter comprises, on a substrate with ground plane, two microstrip lines 10 and 11 connected in series between an input 1 and an output 2. It also comprises 3 line sections or stubs 20, 21 and 22 open circuit at one of their extremities, called first extremities. Microstrip lines 10 and 11 are inserted between the two extremities of the stubs. More particularly, the microstrip line 10 is connected between the second extremity of the stub 20 and the second extremity of the stub 21 and the microstrip line 11 is connected between the second extremity of the stub 21 and the second extremity of the stub 22.

According to the invention, open circuit stubs 30 and 31 are inserted respectively in the microstrip lines 10 and 11.

In this embodiment, the stubs 20, 21, 22, 30 and 31 have noticeably equal lengths, in the order of λ₁/4, λ₁ being the wavelength associated with the central frequency f₁ of the frequency band to cut off or reject.

This type of microstrip line with open circuit stub inserted inside, forming a resonator, is described in a thesis of August 2008 entitled “Advanced Ultra Wideband (UWB) microwave filters for modern wireless communication” made by Hussein Nasser Hamad Shaman at Herriot-Watt University.

This resonator is realised by engraving the transmission line in U form so as to form a line section or stub having a length λ₁/4 and a width Wₛ less than the width W of the transmission line. The transmission lines 10 and 11 have a length L slightly greater than λ₁/4 to make possible the realisation of stubs 30 and 31. As indicated previously, this modification of the length of lines 10 and 11 has little effect on the performances of the filter.

The resonator formed from the transmission line 10 and the open circuit stub 30 and the resonator formed from the transmission line 11 and the open circuit stub 31 are connected in the same direction (open circuit at the same point in the line) or head to tail (opposite direction). In the example of FIG. 3, the two resonators are connected head to tail.

It has been shown that, according to the configuration selected (head to tail or not), a filter can be obtained that has an asymmetric transfer function having a steeper slope to the right or left.

For a filter intended to let the WiFi band pass and filter the DECT band, it is important to increase the right-hand slope of the transfer function of the filter to degrade the WiFi band a little as possible. The selected configuration (head to tail or no stubs 30 and 31) thus varies according to the application.

In this first embodiment, the five stubs 20, 21, 22, 30 and 31 contribute to rejecting a frequency band around the central frequency f₁, which can reach a high level of rejection for this band.

This embodiment is used to reject a single frequency band, for example, the band associated with the DECT or the one associated with the GPS.

According to another embodiment illustrated by FIG. 4, the microstrip lines 10 and 11 respectively comprise open circuit stubs 30′ and 31′ having a length λ₂/4 different from the length λ₁/4 of the stubs 20, 21 and 22, λ₂ being the wavelength associated with the central frequency f₂ of a second frequency band to cut off or reject.

This filter thus enables two frequency bands to be rejected, for example the frequency band associated with the DECT and the one associated with the GPS.

Other resonators can also be added to reject other frequency bands or increase the level of rejection required on a given frequency band. For example, in the embodiment illustrated by FIG. 5, the filter also comprises two other resonators connected in series with the microstrip lines 10 and 11 between the input 1 and the output 2 of the filter.

A first resonator formed from a microstrip line 12 and from a stub 32 inserted within it is connected between the input 1 and the microstrip line 10. A second resonator formed from a microstrip line 13 and from a stub 33 inserted within it is connected between the microstrip line 11 and the output 2.

The length of the stubs 32 and 33 is for example equal to λ₃/4, λ₃ being the wavelength associated with the central frequency f₃ of a third frequency band to cut off or reject. Naturally, it is also possible to use stubs 32 and 33 having the same length as stubs 30 and 31 or stubs 20, 21 and 22 to increase the level of rejection of one of the frequency bands associated with these stubs. The length of the microstrip lines is taken slightly greater than that of the stub that they comprise.

Naturally, according to the level of rejection required on a given frequency band, it can be necessary to add resonators in the filter. The filter topology presented here enables resonators to be added very easily between the input and the output of the filter.

To increase the compactness of the filter, it is possible to realise bends in the microstrip lines 10 to 13 without loss of performance.

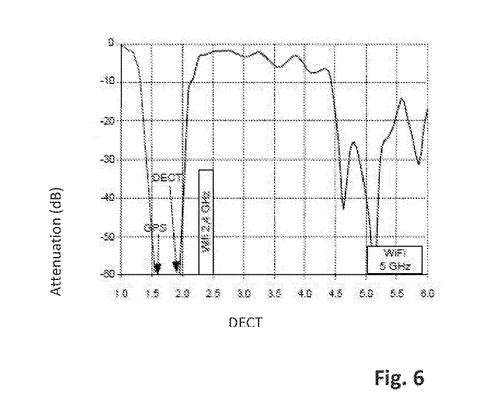

FIG. 6 illustrates the performances of a filter compliant with the filter of FIG. 5 in which the wavelengths λ₁ and λ₃ are equal (λ₁=λ₃) and associated with the central frequency of the frequency band of the DECT and the wavelength λ₂ is associated with the central frequency of the GPS frequency band.

As can be seen in FIG. 6, this filter can be used to reach rejection rates of −60 dB in the GPS and the DECT band without attenuating the 2.4 GHz WiFi band.

This filter topology also has the advantage of hardly being sensitive to drifts related to the parameters of the substrate and the manufacturing tolerances of the stubs or microstrip lines. The rejection performances of the filter are essentially related to the length of the stubs (λ/4). A drift of the impedance of the stubs or the dielectric constant of the substrate only influences the width of the rejected bandwidth.

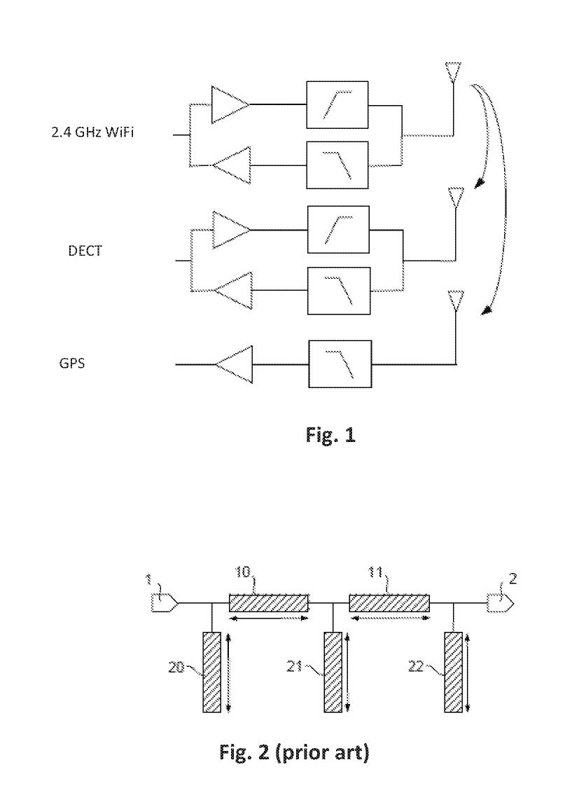

This type of filter is therefore particularly suitable to be used on standard terminals to enable the coexistence on a same printed circuit board between radio systems operating at different frequency bands as in the case illustrated diagrammatically in FIG. 1.

The embodiments described above have been provided as examples. It will be evident to those skilled in the art that they can be modified, particularly concerning the number of resonators, the materials used for the substrate or the transmission lines, the operating frequency bands, etc.

1. Band-rejection filter comprising, on a substrate with a ground plane, three printed line sections or “stubs” open circuit at one of their extremities, called first extremities, and first and second printed transmission lines connected in series between an input terminal and an output terminal and connecting between each other the other extremities, called second extremities, of said stubs, each of said first and second transmission lines being inserted between the second extremities of two stubs, said stubs being dimensioned to reject a first frequency band,
wherein an open circuit stub is inserted in at least one of said first and second printed transmission lines to reject a second frequency band.

2. Filter according to claim 1, wherein the first and second frequency bands are substantially identical.

3. Filter according to claim 1, wherein the first and second frequency bands are different.

4. Filter according to claim 1, wherein an open circuit stub is inserted in each of said two first and second printed transmission lines to reject said second frequency band.

5. Filter according to claim 1, further comprising at least one third printed transmission line in which is inserted an open circuit stub, said third transmission line being mounted in series with said first and second printed transmission lines and inserted between the input terminal and the first transmission line or between the second transmission line and the output terminal, said stub being dimensioned to reject a third frequency band.

6. Filter according to claim 5, wherein said third frequency band is identical to one of said first and second frequency bands.

7. Filter according to claim 5, wherein said third frequency band is different from said first and second frequency bands.

8. Filter according to claim 1, wherein the substrate is a low cost substrate, such as the substrate commonly known as FR4.

9. A wireless electronic device comprising a filter according to claim 1.
